(19) United States
(12) Patent Application Publication
(10) Pub. No.: US 2025/0146889 A1
(43) Pub. Date: May 8, 2025

(54) VIBRATION CONTROL COMPONENT

(71) Applicant: TRELLEBORG ANTIVIBRATION SOLUTIONS GERMANY GMBH, Velten (DE)

(72) Inventor: Patrick ZENKER, Berlin (DE)

(21) Appl. No.: 18/837,687

(22) PCT Filed: Feb. 3, 2023
(86) PCT No.: PCT/EP2023/052739

§ 371 Date: Aug. 12, 2024

(30) Foreign Application Priority Data
Feb. 16, 2022 (DE) 102022103632.4

(51) Int. Cl. G01L 1/10; B61F 5/50; B61K 9/00; G01H 11/02

(52) U.S. Cl. CPC G01L 1/106; B61K 9/00; G01H 11/02; B61F 5/50

(57) ABSTRACT

A vibration control component, comprising at least one bearing element, one spring element and one sensor device, wherein the sensor device comprises at least one sensor and at least one control unit and wherein the sensor device is formed to detect relative movements of the spring element and/or the bearing element.

The invention relates to a vibration control component comprising at least one bearing element, one spring element and one sensor device.

It is known from the state of the art, for example from EP 3 541 642 B1, to detect static and dynamic movements, in particular spring deflections on vibration control components, wherein such detection can also be carried out in particular on rail vehicles. However, complex measuring structures are often required for this; thus, force measurement can usually only be carried out using indirect measuring methods, for example using strain gauges on calibrated metal components or via spring deflection measurement using cable pull potentiometers on spring elements. Due to the limited installation space, displacement measurement on several axes is only possible to a limited extent. It is known from EP 3 541 642 B1 to detect the spring deflection of a vibration control component using a field sensor with a capacitive or inductive measuring principle.

Detecting dynamic loads can also be carried out by means of acceleration measurement. However, the disadvantage here is that it is relatively imprecise and changes in path with small dynamics cannot currently be detected.

Other known sensor arrangements are based on the immersion anchor principle, which is accompanied by limitations in the measurement of highly dynamic loads. Furthermore, these sensors only detect deformations in one direction, which means that an additional sensor is required for each additional direction.

The invention is based on the object of providing a system with a vibration control component which enables the detection of static and dynamic loads acting on the vibration control component.

This object is achieved by the features of claim 1. The subclaims refer to advantageous embodiments.

The vibration control component for achieving the object comprises at least one bearing element, one spring element and one sensor device, wherein the sensor device comprises at least one sensor and at least one control unit, and wherein the sensor device is formed to detect relative movements of the spring element and/or the bearing element.

According to the invention, the sensor device accordingly comprises a sensor and a control unit. The sensor device can form an integrated component which is arranged in the component in such a way that it is protected from external influences. The control unit can detect, store and/or output the values determined by the sensor. For this purpose, the control unit can be connected to a central unit located outside the component via a data line and/or a radio connection. The control unit can also be designed in such a way that it evaluates and/or temporarily stores the values determined by the sensor. For this purpose, the control unit can have a memory, wherein the memory is provided with an autonomously operating evaluation program. Accordingly, the control unit can store measurement data and transfer it to the central unit immediately or at intervals.

The sensor device can have a magnetic measuring principle. The sensor device is configured to detect relative movements or deformations in all three directions in space.

The sensor device comprises at least one magnetic field source, which is mounted in a defined position in the vibration control component. The magnetic field sensor is preferably designed as a Hall sensor.

The magnetic field source is preferably a permanent magnet, for example a ferritic magnet or a neodymium magnet. Ferritic magnets have the advantage of high long-term stability and low costs. Neodymium magnets, on the other hand, have high field strengths.

The sensor device can have at least one or a plurality of magnetic field sources. By changing the number, position and design of the magnetic field source, the sensor device can be adapted to the desired area of application. Just like the number, the design of the magnetic field source is also a substantial parameter for adapting the sensor device. The property of the magnetic field source is influenced overall by its geometry, the material, the number and the polarization direction of the magnetic field source.

The magnetic field sensor can be associated with the spring element or the bearing element. Especially when the magnetic field sensor is associated with the spring element, the magnetic field sensor can be embedded in the spring element. As a result, the magnetic field sensor is particularly well protected against external influences and is particularly robust.

In addition to the magnetic field source, the sensor device can also comprise a device for deforming and/or conducting the magnetic field. This device is a passive component that influences the properties of the magnetic field and affects, for example, the sensitivity of the sensor device or the detected deflection of the magnetic field source. This can be understood to mean, for example, a device that bundles an electromagnetic field. A device with soft magnetic properties is advantageous for this.

The sensor device also comprises a sensor for detecting the magnetic field emitted by the magnetic field source. If the magnetic field source is moved relative to the sensor, the magnetic field detected by the sensor changes. As a result, there is a direct correlation between the static or dynamic deflection of the vibration control component and the change in the magnetic field detected by the sensor. In this respect, the sensor device according to the invention enables direct detection of the static and dynamic load on the vibration control component.

It is conceivable that the sensor device comprises multiple magnetic field sensors, which are arranged in such a way that movement of the vibration control component or movement of a component of the vibration control component is possible in all three directions in space. In principle, it would also be possible to realize three-dimensional detection with just one sensor. However, the use of a plurality of sensors offers the advantages of increased measuring accuracy and greater robustness of the measured value acquisition. Also, tilting of the vibration control component or of a component of the vibration control component can be detected in all three directions in space. This enables complete monitoring of all movements of the vibration control component.

One advantage of the sensor device based on the magnetic measuring principle is the contactless absolute displacement and angle measurement. Deformations are detected in all three directions in space, wherein the sensor device does not impair the properties of the vibration control component. Furthermore, no auxiliary energy acting on the vibration control component, for example by moving components, is required to detect the measured values.

The magnetic field source is preferably formed in such a way that it has constant magnetic properties. In this case, it is possible to determine the distance of the magnetic field sensor relative to the magnetic field source and thereby determine the absolute movements of the vibration control component.

Vibration control components often comprise spring elements made of rubber-elastic materials. These change their spring characteristics depending on the temperature. Furthermore, some rubber-elastic materials also exhibit a change in spring characteristics depending on the ambient humidity. In order to be able to determine the change in spring characteristics depending on temperature and humidity, it is advantageous if the sensor device has a temperature sensor and/or a humidity sensor. Furthermore, a sensor for detecting the temperature of the sensor device can be provided in order to compensate for the temperature dependence of the magnetic field.

The sensor device can have a triaxial acceleration sensor, a microphone, a GPS sensor and/or a gyroscope. The microphone enables the recording of sound signals, which facilitates more precise analysis of the occurrence of damage, particularly during subsequent evaluation, for example in the context of a damage assessment. The GPS sensor and the gyroscope improve the geographical allocation of the other data detected by the sensor device. This is particularly advantageous if damage to stationary equipment such as rails is detected by the sensor device.

The detection of dynamic processes is improved if the sensor device also has an acceleration sensor.

The control unit can comprise a radio module. This enables remote transmission of the data detected by the sensor device. For example, it is possible to carry out real-time monitoring of the vibration control component.

The radio module can transmit the data wirelessly to receiving devices, such as, for example, a central unit or mobile diagnostic devices. However, it is also conceivable that the vibration control component or the sensor device has a connector for a cable connection. The cable connection is particularly preferred for robust use in rail vehicles.

The radio module can be configured to send data via a radio protocol. Transmission can take place locally via WLAN, for example, or remotely via a radio network such as, for example, GSM, UMTS or LTE or via a wireless network standard such as ZigBee.

The control unit can comprise a memory device. The memory device stores the data recorded by the sensor device. The data can then be read out at a freely selectable time via a suitable interface. The data can be read out during maintenance, for example. The memory device can be provided as an alternative and in addition to the radio module or data transmission via cable.

The control unit can be embedded in the component. As a result, the control unit is particularly well protected against external influences. Due to the resulting long service life, this is particularly advantageous in connection with rail vehicles. Preferably, the control unit is associated with the spring body, wherein the control unit can be embedded in the spring body.

The control unit can function as an evaluation unit. For this purpose, the control unit can be equipped with a memory containing an evaluation program for evaluating the measured values detected by the sensor. The raw data from the sensor is converted by the evaluation program so that, for example, a distance between components of the part can be determined from a change in a magnetic field detected by the sensor.

The control unit can comprise a microcontroller. Microcontrollers are compact units that contain a processor and a working memory. The microcontroller can autonomously execute an evaluation program that autonomously records and evaluates sensor data. In addition, the microcontroller can also contain a memory and store measurement data. In principle, it is also conceivable that the microcontroller directly influences the part depending on the data determined by the evaluation program, for example in that the microcontroller issues switching commands to valves that can open or close the fluid lines of a hydraulic bearing.

Vibration control components of rail vehicles are subject to strong dynamic and static interactions. Furthermore, vibration control components of rail vehicles have a long service life, while at the same time the vibration control components are subject to continuous operation. A particularly advantageous use of the vibration control component is therefore when the vibration control component is formed as the primary spring of a rail vehicle. The embodiment according to the invention enables monitoring of the primary spring and also monitoring of the adjacent components. This can be the primary damper associated with the primary spring, for example. But the wheel-rail interface can also be monitored. If the sensor device is designed accordingly, it is possible, for example, to detect flat spots on wheel sets or damage to rails.

In order to be able to detect damage to rails in particular, it is advantageous if the sensor device also has a GPS module. This enables a geographical allocation of the recorded measured values. This means that damage to rails can also be precisely localized at a later date.

A device for providing electrical energy can be associated with the sensor device. The device provides the electrical energy required for the sensor device. Electrical energy may be required, for example, for the function of the magnetic field sensor, for the control unit and for the radio module.

According to a first embodiment, the energy supply takes place via a cable connection to an external power source, which reduces the maintenance effort. According to a second embodiment, the device is formed in the shape of a rechargeable battery. This allows the components of the sensor device to be supplied with electrical energy autonomously.

According to a further embodiment, the device is formed to generate electrical energy by converting the ambient energy. For this purpose, the device has generators, for example in the form of microgenerators, which convert ambient energy, such as vibration energy, impact energy or thermal energy, into electrical energy. The advantage over a rechargeable battery is that the almost unlimited available ambient energy is used to generate electrical energy. This results in a sensor arrangement with an autonomous energy supply and a particularly long service life.

The control unit can store the data detected by the sensor and feed it to the radio module and/or the memory. The control unit can also be designed in such a way that initial processing of the recorded data takes place there. For example, the recorded data can be transferred to a bus-compatible protocol. This can be done via the evaluation program stored in the control unit.

A plurality of vibration control components can be combined into one unit, wherein the data recorded by the sensor unit of each vibration control component is merged in a central unit. Such a unit is formed, for example, by the bogie of a rail vehicle. The bogie has several vibration control components, for example several primary springs. A central unit can be associated with the bogie, which centrally records the data recorded by the sensor devices of all primary springs arranged on the bogie. Data transmission from the vibration control components to the central unit can take place wirelessly via the radio module or via a wired network. The central unit can have an evaluation unit, a memory unit and a radio module. The recorded data can be pre-processed by the evaluation unit. By evaluating the data of all vibration control devices a monitoring of the entire system can take place. For example, it is possible to monitor the function of the bogie and the associated individual components.

The data recorded by the sensor device or the central unit can be provided with a time stamp. The measurement signals are synchronized by means of a real-time clock or a time signal provided by the vehicle.

The sensor device can have devices for optimizing the energy requirement. This can extend the operating time of the sensor device, especially when using rechargeable batteries. This can be achieved, for example, by targeted switching off and/or transferring of the sensor device to standby mode or sleep mode. The device can also have switching components that allow the sensor device to be completely disconnected from the rechargeable battery.

The sensor device enables monitoring of the vibration control component. If a plurality of vibration control components are combined into one unit, it is also possible to monitor the entire unit. Vibration control components are already versatile and have been in use for many years. Damage mechanisms are therefore already known. By knowing the actual deformations of the vibration component, which are detected by the sensor device, and by knowing the damage mechanisms, evaluations of the individual vibration control component and the entire monitored unit can be carried out in real time. This makes it possible, for example, to accumulate damage to the component and calculate the remaining service life. An evaluation of the unit which the vibration control components are associated with can also be carried out. This can be the bogie of a rail vehicle, for example.

The acceleration sensor enables the detection of periodic processes caused by wheel bearings or gearboxes, for example.

There may be air between the magnetic field source and the magnetic field sensor. This can be the case in primary springs or air springs, for example. It is also conceivable that the spring element is located between the magnetic field source and the magnetic field sensor. This is the case with layer springs, for example. It is also conceivable that there is a fluid between the magnetic field source and the magnetic field sensor. This is the case with hydromounts, for example.

An exemplary embodiment of the vibration control component is explained in more detail below with reference to the figure. The figure shows schematically:

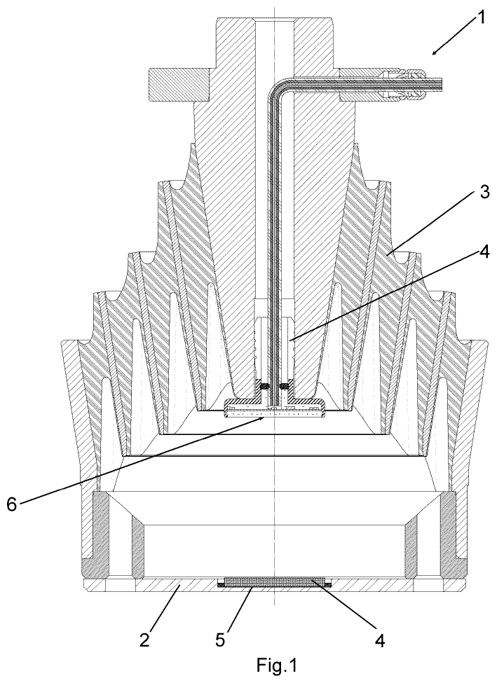

FIG. 1 a primary spring in sectional view.

FIG. 1 shows a primary spring of a rail vehicle. Said primary spring forms a vibration control component 1. The vibration control component 1 comprises a bearing element 2 made of metallic material, a spring element 3 made of rubber-elastic material and a sensor device 4. The sensor device 4 is formed to detect relative movements of spring element 3 and bearing element 2. The sensor device comprises a sensor and a control unit.

The sensor of the sensor device 4 has a magnetic measuring principle. For this purpose, the sensor device 4 has a magnetic field source 5 and a magnetic field sensor 6. These are arranged at a distance from each other in the vibration control component 1. The magnetic field sensor 6 is associated with the spring element 3 and the magnetic field source 5 is associated with the bearing element 2. In the present embodiment, the magnetic field sensor 6 is associated with the spring element 3. For this purpose, the magnetic field sensor 6 can also be embedded in the spring element.

In order to compensate for environmental influences, the sensor device 4 also comprises a temperature sensor and an acceleration sensor. The sensor device 4 also has a microphone for recording ambient noise. In addition, a humidity sensor can be provided.

In the present embodiment, the sensor device 4 transmits the data via a cable connection. In an alternative embodiment, the sensor device 4 also comprises a radio module in addition to the control unit. The radio module enables radio transmission of the data recorded by the sensor device 4. The control unit stores the data recorded by the sensor device 4.

The control unit is formed as a microcontroller, which comprises a processor and a main memory. The microcontroller is configured to execute an evaluation program autonomously. This allows the control unit to record and convert the raw data detected by the sensor. In an alternative embodiment, the microcontroller also comprises a memory so that raw data and/or evaluated data can be stored in the microcontroller. In particular, the control unit can convert the raw data into distance data.

An arrangement comprises a plurality of vibration control components 1. The vibration control components 1 in turn comprise at least one bearing element, one spring element and one sensor device, wherein the sensor device is formed to detect relative movements of the spring element and/or bearing element. The measurement data recorded by the sensor devices of the vibration control components 1 are stored and/or processed in the central unit. For this purpose, the sensor devices are connected to the central unit via a wired data line. Alternatively, it is conceivable that the data recorded by the sensor device 4 is transmitted wirelessly to the central unit via a radio connection.

In the case of a wired connection between the central unit and the vibration control component 1, an energy supply for the sensor device 4 can take place via the central unit.

The central unit can comprise a memory that stores the data recorded by the sensor devices 4. Furthermore, the central unit can be equipped with a device by means of which the data recorded by the sensor devices can be forwarded or read out. For this purpose, the central unit can have a radio module. Furthermore, the central unit can have an interface for connecting a wired readout unit.

A plurality of vibration control components 1 can be combined to form a vibration control unit, wherein one central unit is provided for each vibration control unit. In this embodiment, an arrangement can have a plurality of vibration control components 1 and a plurality of central units. The vibration control components 1 are preferably associated with a vibration control unit or a component group. The central units can be connected to each other.

For example, a rail vehicle forms one arrangement. The rail vehicle has a plurality of bogies and each bogie in turn has a plurality of wheel sets. Each wheel set has a plurality of vibration control components 1, wherein the vibration control components 1 are at least partially provided with a sensor arrangement 4. For example, the primary springs of a bogie can be equipped with a sensor system.

The data recorded by the sensor devices 4 arranged in the vibration control components are each transmitted to a central unit, wherein one central unit is provided for each bogie. The rail vehicle in turn has a plurality of carriages, wherein each carriage has two bogies. Thus, each carriage has two central units with a plurality of vibration control components 1 in turn associated with each central unit.

What is claimed is:

1. A vibration control component, comprising at least one bearing element, one spring element and one sensor device, wherein the sensor device comprises at least one sensor and at least one control unit and wherein the sensor device is formed to detect relative movements of the spring element and/or the bearing element.

2. The component according to claim 1, wherein the sensor device has a magnetic measuring principle.

3. The component according to claim 2, wherein the sensor device comprises at least one magnetic field source and at least one magnetic field sensor, which are arranged at a distance from one another in the component.

4. The component according to claim 2, wherein the magnetic field sensor is formed as a Hall sensor.

5. The component according to wherein the magnetic field sensor is associated with the spring element or the bearing element.

6. The component according to, wherein the magnetic field sensor is embedded in the spring element.

7. The component according to claim 1, wherein the sensor device comprises a temperature sensor and/or a humidity sensor and/or an acceleration sensor.

8. The component according to claim 1, wherein the control unit comprises a radio module.

9. The component according to claim 1, wherein the control unit comprises a memory device.

10. The component according to claim 1, wherein the control unit is embedded in the component.

11. The component according to claim 1, wherein the control unit functions as an evaluation unit.

12. The component according to claim 1, wherein the control unit comprises a microcontroller.

13. The vibration control component according to claim 1 formed as a primary spring of a rail vehicle.

14. An arrangement comprising a plurality of vibration control components according to claim 1 and at least one central unit which stores and/or processes the measurement data recorded by the sensors of the vibration control components.
